(19) United States
(12) Patent Application Publication
(10) Pub. No.: US 2004/0075222 A1
(43) Pub. Date: Apr. 22, 2004

(54) Robotically places and formed magnetic adhesive gaskets

(75) Inventors: Theodore A. Wegert, Louisville, KY (US); Karen Cary, Louisville, KY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Corporation, Yonkers, NY (US)

(21) Appl. No.: 10/686,058

(22) Filed: Oct. 14, 2003

Related U.S. Application Data
(60) Provisional application No. 60/418,495, filed on Oct. 15, 2002.

(51) Int. Cl. F16J 15/53; B29C 31/00

(52) U.S. Cl. 277/629; 277/650; 264/259

(57) ABSTRACT

A gasket for sealing an appliance door and a method for forming the gasket on an appliance surface are provided. The gasket, formed of gasket material with magnetic properties, is attached to an appliance door shell. The gasket material uses the magnetic properties to releasably engage a mating door jamb when the door shell is in a closed position. Alternatively, the gasket includes a magnetic strip covered by formed-in-place gasket material. A method for forming the gasket in-place is also provided.

### CROSS REFERENCE TO RELATED APPLICATION

This application claims the benefit of U.S. Provisional Patent Application No. 60/418,495, filed Oct. 15, 2002, which is incorporated by reference herein as if fully set forth.

### BACKGROUND

The present invention relates to a gasket structure for providing a seal between a door and a surrounding structure, and in particular provides an improved refrigerator or freezer door gasket.

Refrigerator/freezer door gaskets are typically attached via physical means to refrigerator/freezer doors. The gaskets adhere to the opposing refrigerator door opening frames when the door is closed by magnetic strips contained within gasket systems.

Such gaskets typically include a base formed of a semi-rigid thermoplastic elastomer material that can be secured to the inner surface of the door around the periphery where the door faces the door opening frame. A jacket formed of a flexible thermoplastic elastomer material having a flexible bellows-like structure extends from the base and a magnetic strip is located therein. As the door closes, the gasket magnetically engages a selected part of the door opening frame to form a seal and the flexible bellows-like structure allows a predetermined amount of extension and/or compression of the magnetic sealing gasket so that a complete contact between the gasket and frame is achieved. This provides an effective thermal and/or hermetic seal between the door and the frame.

However, the door gaskets and magnetic inserts are formed through different processes, typically at different locations, and due to the complex shape and rigid form of the completed gasket assembly, transportation of the gasket is both cumbersome and significantly expensive.

### SUMMARY

The present invention provides a novel gasket for sealing an appliance door and a method for forming the novel gasket on a suitable surface.

In one embodiment, the gasket includes magnetic gasket material attached by an adhesive to an appliance door shell or removable panel. The gasket material forms a pair of sealing lips which provide the necessary configuration to releasably engage a mating door jamb when the door shell is in a closed position. The magnetic gasket material may be an RTV (room temperature vulcanizing) sealant, or other suitable elastomer, with a mixed-in magnetizable material such as ferrite and/or rare earth powder.

In another embodiment the gasket includes a magnetic strip or wire covered by formed-in-place gasket material. An adhesive or an adhesion promoter is used to attach the magnetic strip to the gasket material, and to attach both the gasket material and the magnetic strip to the door shell.

Other embodiments employ the above configurations and additionally provide perforations in the door shell. Portions of the gasket material protrude through the perforations providing an anchor for the gasket.

A method for forming the above embodiments includes the steps of applying a continuous length of form-in-place gasket material on the door shell and curing the gasket material. Adhesion promoters or adhesives may be applied to connect the gasket material to a magnetic strip or connect the gasket to the door shell. Also, providing a door shell having perforations allows the form-in-place gasket material to flow through the perforations during application to create an anchor after curing.

### BRIEF DESCRIPTION OF THE DRAWINGS

FIG. 1 is a cross-sectional view of a V-shaped gasket mounted on an appliance door in accordance with the present invention.

FIG. 2 is a cross-sectional view of the V-shaped gasket of FIG. 1, shown with the appliance door in a closed position.

FIG. 3 is a cross-sectional view of a V-shaped gasket mounted on an appliance door according to another embodiment of the invention.

FIG. 4 is a cross-sectional view of a tongue-and-groove-shaped gasket mounted on an appliance door in accordance with the present invention.

FIG. 5 is a cross-sectional view of the tongue-and-groove-shaped gasket of FIG. 4, with the appliance door in a closed position.

FIG. 6 is a cross-sectional view of a formed-in-place gasket, which contains a magnetic strip, mounted on an appliance door in accordance with the present invention.

FIG. 7 is a cross-sectional view of a second embodiment of a formed-in-place gasket containing a magnetic strip according to another embodiment of the invention.

FIG. 8 is a cross-sectional view of a third embodiment of a formed-in-place gasket containing a magnetic strip in accordance with the present invention.

FIG. 9 is a perspective view showing the formation of a gasket on an appliance door according to the present invention.

FIG. 10 is a perspective view showing the formation of a gasket on a flat panel according to the present invention.

FIG. 11 is a perspective view showing the formation of a gasket on a curved panel according to the present invention.

### DETAILED DESCRIPTION OF THE PREFERRED EMBODIMENTS

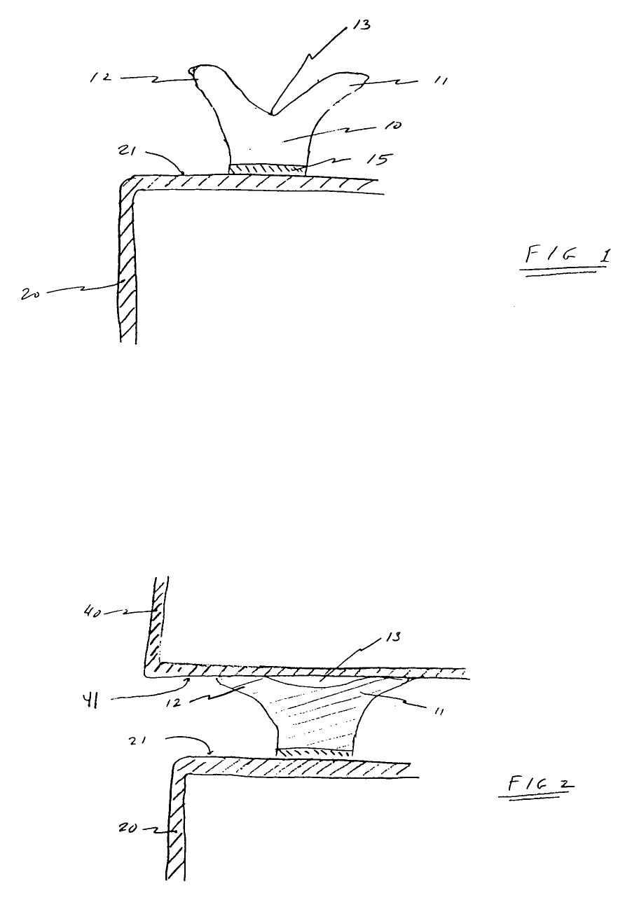

FIG. 1 shows a cross-sectional view of a gasket 10 in accordance with the present invention adhered to a door shell 20. The gasket 10 is formed of a magnetic gasket material, such as an FDA approved RTV sealant with a mixed in magnetic or magnetizable material. The magnetic or magnetizable material may be a ferrite powder, or alternatively, a rare earth powder such as neodymium-iron-boron. In addition to RTV sealant, other suitable elastomers which may be ambient, heat or UV cured may also be used. The gasket 10 has two sealing lips 11, 12, separated by a gasket well 13. The size of the lips 11, 12, and the size of the well 13 compared to the size of the gasket 10 are dependent on several variables. These variables include the dimensions of the appliance, the separation between the door and the door jamb, the required force needed to maintain the seal, the flexibility of the gasket material, as well as other variables such as aesthetic considerations.

As shown in FIG. 1, the gasket 10 can be attached to the door shell 20 by an adhesive 15. Such adhesive can be placed on to the door shell prior to forming the gasket in place, or the gasket material itself may have sufficient adhesive properties to affix itself to the door shell 20. The sealing lips 11 and 12 may be symmetric or asymmetric depending on the particular application.

The door shell 20 is preferably part of a hinged door, or alternatively part of a non-hinged panel, such as an appliance outer shell, removable for cleaning, repair or replacement. The door shell 20 may be constructed of any structurally suitable material, magnetic or non-magnetic, including glass, metal, ceramics, or plastics. Alternatively, the gasket 10 may be provided on the surface of any article such that the article may be removably affixed to a magnetic surface for storage or display. For example, a kitchen article such as a bread board, serving tray, or the like may be temporarily affixed to the steel panel of a refrigerator, stove, or other appliance.

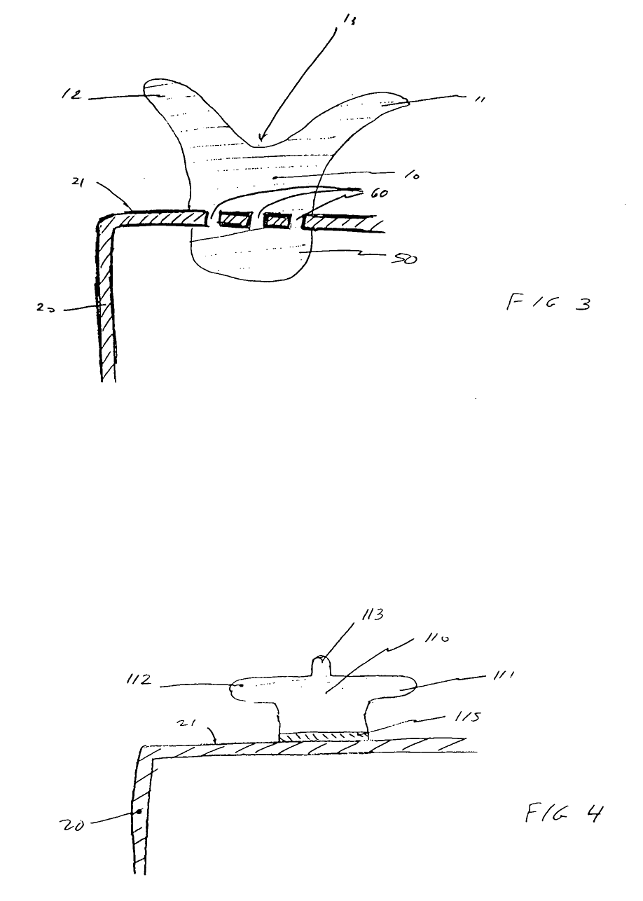

FIG. 2 shows the door shell 20 being in a closed position with the gasket 10 forming a tight seal between the door shell 20 and a door jamb 40 which presents interfacing surfaces 21,41. The doorjamb 40 may be a part of a refrigerator or freezer cabinet or door opening frame, or alternatively, may define an opening or placement area for any type of removable panel, hinged or unhinged, functional or decorative. The door jamb 40 is made out of a magnetic material that is attracted to magnetic material of the gasket 10. The lips 11 and 12 are sealed magnetically to the doorjamb surface 41.

Another embodiment of the present invention is shown in FIG. 3. In this embodiment the door shell 20 is not a continuous, monolithic body, but has perforations 60 along the area where the gasket 10 is to be formed. Such perforated holes 60 may be in any shape that would allow the forming matrix of the gasket material to flow during the formation stage through the holes 60 and form an anchor portion 50 on the other side of the perforations 60. The perforations 60 are large enough to allow sufficient amount of material to flow through to hold the gasket 10 in place, but do not weaken the structure of the door shell 20. The perforations 60 may have any profile including, but not limited to, circular, oblong, elliptical, mesh, square, rectangular, hexagonal, triangular, etc. The advantage of this embodiment, as shown in FIG. 3, is that the gasket is held in place mechanically, thus it will reduce the possibility of adhesion or cohesion failure between the gasket 10 and the door shell 20. The sealing of the door shell 20 to the door jamb by the gasket 10 according to embodiment as shown if FIG. 3 will perform in a similar manner as the gasket shown in FIG. 1.

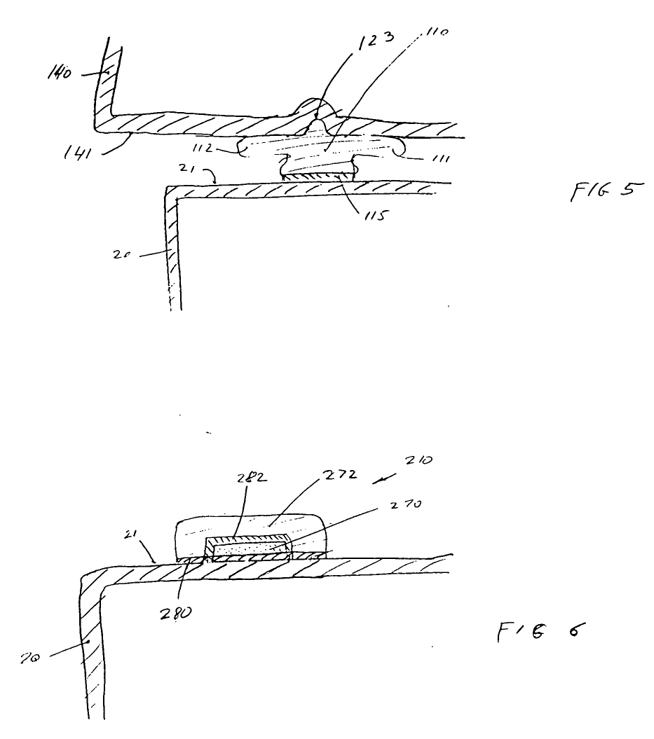

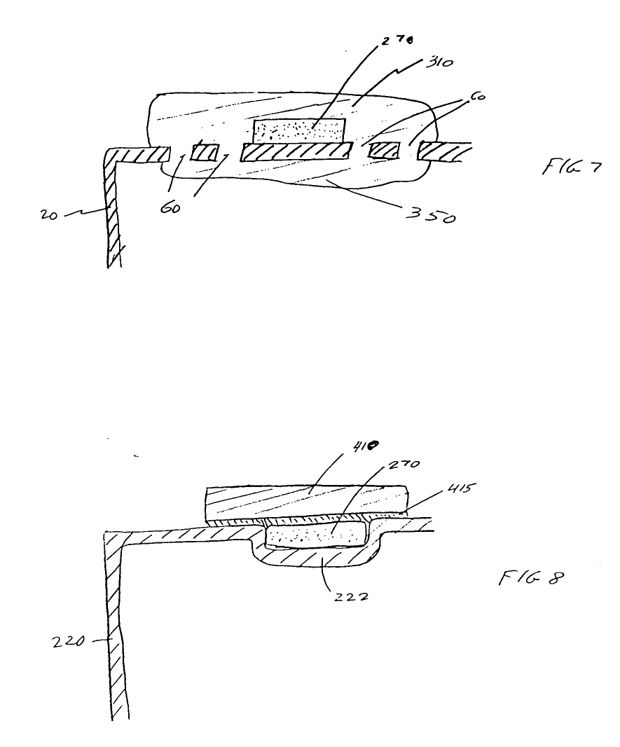

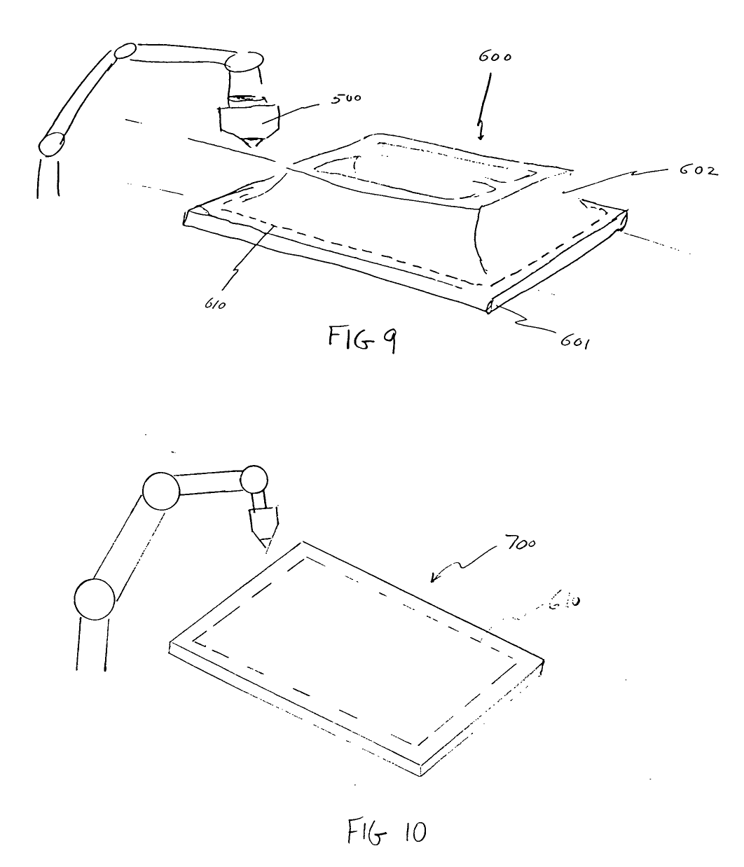

An alternative embodiment of the gasket 10 is shown in FIG. 4. In this embodiment, the gasket 110 does not have a V-shape like the gasket 10 shown in FIG. 1, but rather has a tongue and groove configuration. The surfaces of the lips 111 and 112 adhere to the door jamb in such a way to create an air sealed junction. The surfaces of the lips 111, 112 may be parallel to the surface 21 or they may be sloped to mirror the surfaces on the door jamb. The gasket 110 also contains a tongue 113 located between the lips 111 and 112. This tongue 113 fits into a groove 123 of the door frame 140, as shown in FIG. 5. The geometry of the groove 123 should be such that air trapped between the tongue 113 and groove 123 is able to escape to form a tight seal, but does not allow any air to ingress after sealing. The two lips 111 and 112 are not necessarily symmetric. One of them may be longer, thicker, or a combination of the two, than the other.

It is also possible to form gasket 110 in a similar manner to that shown in FIG. 3: namely, such a gasket may be formed on a door shell that has perforations, thus allowing the gasket matrix to extend through the appropriate perforations to form an anchor, thus assuring that the gasket is attached to the door shell material by mechanical means and not by adhesive 115 as shown in FIG. 4.

A gasket 210 in accordance with another embodiment of the present invention is shown in FIG. 6. The gasket 210 is comprised of a strip of magnetic material 270 which is covered by a formed-in-place gasket material 272. Adhesive layers or adhesion promoters 280, 282 may be utilized, if necessary, to assist in bonding the materials together and to the door 20. The gasket 210 may have any geometry, as long as it forms a good seal between the door shell and door jamb. The embedded magnetic material 270 may be a single strip of magnetic material, or it may be a plurality of strips. Furthermore, the magnetic material may take any geometric shape, as long as its presence contributes to the sealing of the door shell to the door jamb.

An alternate embodiment of the gasket 310 in accordance with the invention is shown in FIG. 7. In this embodiment, door shell 20 includes perforations 60. The magnetic strip 270 is placed on the shell 20 in such a way that the perforations 60 can be found on either side of the magnetic strip 270. After the magnetic strip 270 is in position, the gasket material is formed in place. The gasket material extends through the perforations 60, so that an anchor portion 350 is formed on the other side of the door shell, to hold the gasket 310 in place.

It is understood that the surfaces of the gaskets 210 and 310 are not necessarily parallel to the door jamb surface. It is possible for this surface to have other geometric features such as sealing lips, tongue and groove features, either singly or in a plurality of formations. It is recognized, that it is not necessary that the thickness of the gasket to be very great. For example, in order to increase the effectiveness of the sealing mechanism due to the magnetic attraction of magnet 270 to the door jamb, the thickness of the gasket material over the magnet 270 may be rather small. Alternatively, the strength of the magnet 270 can be adjusted based on the thickness of the gasket.

Another embodiment of the gasket 410 in accordance with the present invention is shown in FIG. 8. In this embodiment, the door shell 220 has a well 222 into which magnetic material 270 is placed. After placement of the magnetic material into the well 222, the gasket material is formed in place to form the magnetic gasket 410. An adhesive or adhesion promoter 415 can be used between the gasket material and the door and/or magnet 270. It is possible that the magnetic material 270 is adhered via adhesive in the well 222. Like the gasket 310, the surface of gasket material 410 need not be flat. It is possible, that the surface is comprised of several geometric features such as sealing lips, tongue and groove features, etc.

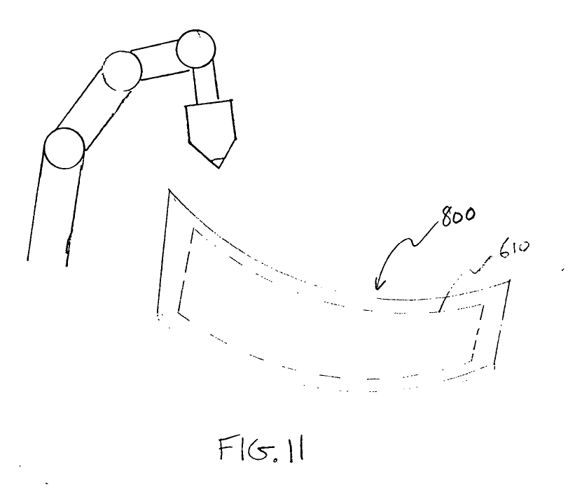

Another aspect of this invention is the process of making a refrigerator door assembly or other flat panel or component that requires a seal. As shown in FIG. 9, an in-place forming apparatus that dispenses or extrudes the form-in-place gasket material is located along the factory line. A partially formed refrigerator or freezer door 600 comprised of an outer shell 601 and inner liner 602 is located in desired positions adjacent to a dispensing head 500 that extrudes or dispenses the form-in-place material 610 used to form the gasket. This can be extruded with the desired shape, or may be otherwise formed with the magnetic material mixed in with the gasket forming elastomer. While a refrigerator door is shown in FIG. 9, the form-in-place material 610 could be applied to a simple flat panel 700, as shown in FIG. 10, or even a curved panel 800, as shown in FIG. 11. The flat and curved panels 700, 800 may be representative of fascias, doors, covers or basic household articles requiring a permanently magnetized surface.

After the gasket is formed it is magnetized and cured on the assembly line. Alternatively, it can be preformed and/or premagnetized. An advantage of the use of present technology is that it is possible to form the gaskets on site, and preferably in place on glass or plastic surfaces and/or on non-assembled frames and/or doors, thus eliminating the costly shipping of voluminous gaskets as well as additional handling. Additionally, multiple components are not required from different locations, and labor costs for assembly are avoided. A further advantage is the easy formation of custom-made gaskets to any desired size and with custom colors.

The coloring of gaskets can be performed by addition of coloring agents into the gasket mixture. The colorants should be of stable nature so they do not decompose under everyday conditions in a residential setting.

Each of the above embodiments describes a gasket permanently connected to an appliance door shell. However, those skilled in the art recognize that gaskets of the types described may be permanently connected to any suitable surface including an appliance door jamb.

While the preferred embodiment of the invention has been described in detail, the invention is not limited to the specific embodiment described above, which should be considered as merely exemplary. Further modifications and extensions of the present invention may be developed, and all such modifications are deemed to be within the scope of the present invention as defined by the appended claims.

What is claimed is:

1. An appliance door gasket for an appliance including a door shell and a door jamb, the door gasket comprising a formed-in-place magnetic gasket material having at least one free surface for detachably connecting the gasket to one of the door shell and the door jamb, and having at least one secured surface, for permanently connecting the gasket to the other one of the door shell and the door jamb.

2. The door gasket according to claim 1, wherein the gasket material comprises a mixture of RTV sealant and magnetizable material.

3. The door gasket according to claim 2, wherein the magnetizable material is a ferrite powder.

4. The door gasket according to claim 2, wherein the magnetizable material includes rare earth material.

5. The door gasket according to claim 4, wherein the rare earth material includes neodymium-iron-boron material.

6. The door gasket according to claim 1, wherein the gasket material is a heat cured elastomer.

7. The door gasket according to claim 1, wherein the gasket material is a UV cured elastomer.

8. The door gasket according to claim 1, wherein the at least one free surface comprises a pair of extended sealing lips separated by a gasket well.

9. The door gasket according to claim 8, wherein the sealing lips extend away from the secured surface and away from a plane passing through a center of the gasket perpendicular to the secured surface.

10. The door gasket according to claim 1, wherein the at least one free surface comprises a pair of extended sealing lips and at least one tongue extending away from the secured surface.

11. The door gasket according to claim 1, wherein the gasket material is formed through perforations in one of the door shell and the door jamb.

12. The door gasket according to claim 1, wherein at least one magnetic strip is connected to the one of the door jamb and the door shell, and the gasket material is located over the magnetic strip, whereby the magnetic strip transmits a magnetic force through the gasket material to draw together the door shell and the door jamb.

13. An appliance providing a sealed enclosure comprising:
a door shell;
a door jamb;
an interfacing surface positioned on one of the door shell and the door jamb; and
a formed-in-place magnetic gasket material formed on the interfacing surface.

14. The appliance according to claim 13, further comprising a plurality of perforations arranged on the interfacing surface, wherein the formed-in-place gasket material includes a plurality of portions protruding through the plurality of perforations, and whereby the gasket material is anchored by the portions of the gasket material which pass through the plurality of perforations.

15. The appliance according to claim 13, wherein the gasket material is magnetizable material.

16. The appliance according to claim 13, further comprising a magnetic strip connected substantially between the gasket material and the interfacing surface.

17. The appliance according to claim 16, wherein the magnetic strip is positioned on the interfacing surface substantially between the plurality of perforations.

18. The appliance according to claim 13, wherein the door shell is formed integral with a substantially flat panel, and the door jamb defines a placement area for the flat panel.

19. The appliance according to claim 18, wherein the flat panel is glass.

20. The appliance according to claim 13, wherein the door shell is formed integral with a substantially curved panel, and the door jamb defines a placement area for the curved panel.

21. A method of manufacturing formed-in-place gaskets for appliances comprising:
providing one of a door shell and a door jamb;
applying a substantially continuous length of curable gasket material on a surface of the one of the door shell and the door jamb; and
curing the gasket material.

22. The method according to claim 21, wherein the step of applying includes applying a pre-magnetized gasket material.

23. The method according to claim 21, wherein the gasket material is magnetized subsequent to the step of applying.

24. The method according to claim 21, further comprising applying a magnetic strip on the surface of the one of the door shell and the door jamb prior to the step of applying the gasket material, wherein the curable gasket material is applied over a surface of the magnetic strip.

25. The method according to claim 24, wherein the step of applying the magnetic strip includes applying the magnetic strip substantially flush with the surface of the one of the door shell and the door jamb.

26. The method according to claim 21, wherein the step of applying the gasket material includes applying a gasket material having a substantially uniform cross-section with a pair of extended sealing lips separated by a gasket well.

27. The method according to claim 21, wherein the step of providing one of a door shell and a door jamb includes providing the one of the door shell and the door jamb with a plurality of perforations, and wherein the step applying the gasket material includes applying gasket material such that the material protrudes through the plurality of perforations forming an anchor to secure the gasket material.

28. The method according to claim 21, wherein the step of applying includes applying a curable gasket material having at least one coloring agent.

29. The method according to claim 21, wherein the step of providing includes providing a door shell which is formed integral with a substantially flat panel.

30. The method according to claim 21, wherein the step of providing includes providing a door shell formed integral with a substantially non-ferrous panel.

31. The method according to claim 21, wherein the step of applying includes applying a self-adhesive curable gasket material compatible with the surface of the one of the door shell and door jamb to substantially permanently adhere the gasket material to the one of the door shell and door jamb.

32. A method of manufacturing a formed-in-place permanent magnet for articles comprising:
providing an article;
applying a substantially continuous length of form-in-place, magnetic, curable gasket material on a surface of the article;
curing the gasket material; and
magnetizing the gasket material.

33. The method according to claim 32, wherein the step of providing includes providing a non-ferrous article.
